(19) United States
(12) Patent Application Publication
(10) Pub. No.: US 2024/0328390 A1
(43) Pub. Date: Oct. 3, 2024

(54) FLOATING WIND POWER GENERATION SYSTEM USING SAILING SHIP

(71) Applicant: TOYOTA JIDOSHA KABUSHIKI KAISHA, Toyota-shi (JP)

(72) Inventors: Tateru FUKAGAWA, Fujisawa-shi (JP); Hayato MASUKI, Fuji-shi (JP); Kazutaka KIMURA, Mishima-shi (JP)

(73) Assignee: TOYOTA JIDOSHA KABUSHIKI KAISHA, Toyota-shi (JP)

(21) Appl. No.: 18/534,918

(22) Filed: Dec. 11, 2023

(30) Foreign Application Priority Data
Mar. 28, 2023 (JP) 2023-051773

(51) Int. Cl. F03D 9/32; B63B 35/44; B63H 9/069; F03D 13/25

(52) U.S. Cl. CPC F03D 9/322; B63B 35/44; B63H 9/069; F03D 13/256; B63B 2035/446; F05B 2240/931; F05B 2240/95

(57) ABSTRACT

A floating wind power generation system consists of a hull equipped with a sail, a kite connected to the hull via a tether, a lateral force generating unit that generates lateral force in a direction approximately perpendicular to the longitudinal direction of the hull, and a lateral force generator at the bow of the hull. A steering device for controlling the direction, and a control unit for controlling at least one of the angle of the sail and the steering device so that the tension of the kite is reduced by the lateral force.

### CROSS-REFERENCE TO RELATED APPLICATION

This application claims priority to Japanese Patent Application No. 2023-051773 filed on Mar. 28, 2023, incorporated herein by reference in its entirety.

### BACKGROUND

### 1. Technical Field

The present disclosure relates to a floating wind power generation system using a sailing ship.

### 2. Description of Related Art

WO 2021/094987 discloses a floating wind power generation system in which a kite via an engine is flown from a floating body on the ocean such as a ship equipped with a propulsion device, and power is generated by winding and unwinding a tether connected to the kite.

### SUMMARY

As described above, when wind power generation is performed using a kite on the ocean, and a floating body is not moored, the floating body is dragged by the kite and flowed. Therefore, a relative wind speed to the kite decreases, resulting in a decrease in power generation efficiency. Furthermore, when operating a propulsion device such as a propeller or a screw provided on the floating body to suppress movement of the floating body, energy is required to operate the propulsion device, so there is room for improvement.

In consideration of the above-mentioned fact, an object of the present disclosure is to provide a floating wind power generation system using a sailing ship that can suppress a decrease in power generation efficiency with less energy.

A floating wind power generation system using a sailing ship according to the present disclosure as described in claim 1 includes:
a hull including a sail;
a kite connected to the hull via a tether;
a lateral force generating unit that generates a lateral force in a direction substantially orthogonal to a traveling direction of the hull;
a control unit that controls at least one of an angle of the sail and the steering device such that tension of the kite is reduced by the lateral force.

When power is generated by the kite, and the kite is located in a leeward direction, for example, the hull is pulled in the leeward direction by the tension of the kite. Therefore, in the floating wind power generation system using the sailing ship according to the present disclosure as described in claim 1, the control unit controls at least one of the angle of the sail and the steering device such that the tension of the kite connected to the hull provided with the sail via the tether is reduced by the lateral force generated by the lateral force generating unit.

As described above, by controlling at least one of the angle of the sail and the steering device, the tension of the kite can be reduced by the lateral force. This can suppress the hull from being pulled by the kite with less energy than a case where a propulsion device such as a propeller or a screw is used. As a result, it is possible to suppress a decrease in the relative wind speed to the kite, so that it is possible to suppress a decrease in power generation efficiency with less energy.

In the floating wind power generation system using the a sailing ship according to the present disclosure as described in claim 2, in a configuration described in claim 1, the control unit controls at least one of the angle of the sail and the steering device such that a vector direction of the tension of the kite and a traveling direction of the hull are substantially orthogonal to each other when viewed from above the hull. Here, “substantially orthogonal” is intended to include not only completely orthogonal direction but also a slight permissible range.

In the floating wind power generation system using the sailing ship according to the present disclosure as described in claim 2, the control unit controls at least one of the angle of the sail and the steering device such that a vector direction of the tension of the kite and a traveling direction of the hull are substantially orthogonal to each other when viewed from above the hull. As described above, by making the traveling direction of the hull substantially orthogonal to the vector direction of the tension of the kite, the lateral force that is substantially orthogonal to the traveling direction of the hull can be applied in a direction opposite to the vector direction of the tension of the kite. Thereby, the tension of the kite can be reduced more effectively.

In the floating wind power generation system using the sailing ship according to the present disclosure as described in claim 3, in a configuration described in claim 1 or 2,
the lateral force generating unit includes a plate member on a bottom surface of the hull, the plate member being provided to extend in the front-rear direction of the hull.

In the floating wind power generation system using the sailing ship according to the present disclosure as described in claim 3, the lateral force generating unit includes a plate member on a bottom surface of the hull, the plate member being provided to extend in the front-rear direction of the hull. By providing the plate member on the bottom surface of the hull in this manner, the depth dimension relative to the overall length dimension of the hull can be increased by the plate member, and the magnitude of the lateral force can be changed by the depth dimension of the plate member.

In the floating wind power generation system using the sailing ship according to the present disclosure as described in claim 4, in a configuration described in claim 1 or 2,
in the lateral force generating unit, a ratio between a depth dimension and a width dimension is increased by reducing the width dimension as the depth dimension increases at a bottom portion of the hull located below a water surface.

In the floating wind power generation system using the sailing ship according to the present disclosure as described in claim 4, by increasing the ratio between the depth dimension and the width dimension of the hull, the flow velocity around the hull can be made faster, so that it is possible to easily generate the lateral force.

In the floating wind power generation system using the sailing ship according to the present disclosure as described in claim 5, in a configuration described in to claim 1 or 2,
the lateral force generating unit is provided with a keel extending in the front-rear direction of the hull at a bottom portion of the hull located below a water surface.

In the floating wind power generation system using the sailing ship according to the present disclosure as described in claim 5, since the keel extending in the front-rear direction of the hull is provided at the bottom portion of the hull located below the water surface, the magnitude of the lateral force can be changed depending on the depth dimension of the keel.

As described above, the floating wind power generation system using the sailing ship according to the present disclosure has the excellent effect of suppressing a decrease in power generation efficiency with less energy.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram schematically showing the configuration of a floating wind power generation system using a sailing ship according to a first embodiment of the present disclosure;

FIG. 2 is a front view showing a schematic configuration of the lower part of the sailing ship including a lateral force generating unit;

FIG. 3 is a diagram showing the relationship between relative wind speed, traveling speed, and wind speed with respect to a sailing ship;

FIG. 4 is a top view showing the relationship between the sail angle and the force applied to the sailing ship as seen from above;

FIG. 5 is a plan view for explaining the lateral force generation method;

FIG. 6 is a plan view illustrating the force relationship applied to the sailing ship;

FIG. 7 is a plan view for explaining a lateral force generation method in a modification of the first embodiment;

FIG. 8 is a plan view for explaining a lateral force generation method in another modification of the first embodiment;

FIG. 9 is a plan view for explaining a lateral force generation method in still another modification of the first embodiment;

FIG. 10 is an enlarged plan view of the board of FIG. 9; and

FIG. 11 is a front view showing the lower structure of a sailing ship according to the second embodiment.

### DETAILED DESCRIPTION OF EMBODIMENTS

### First Embodiment

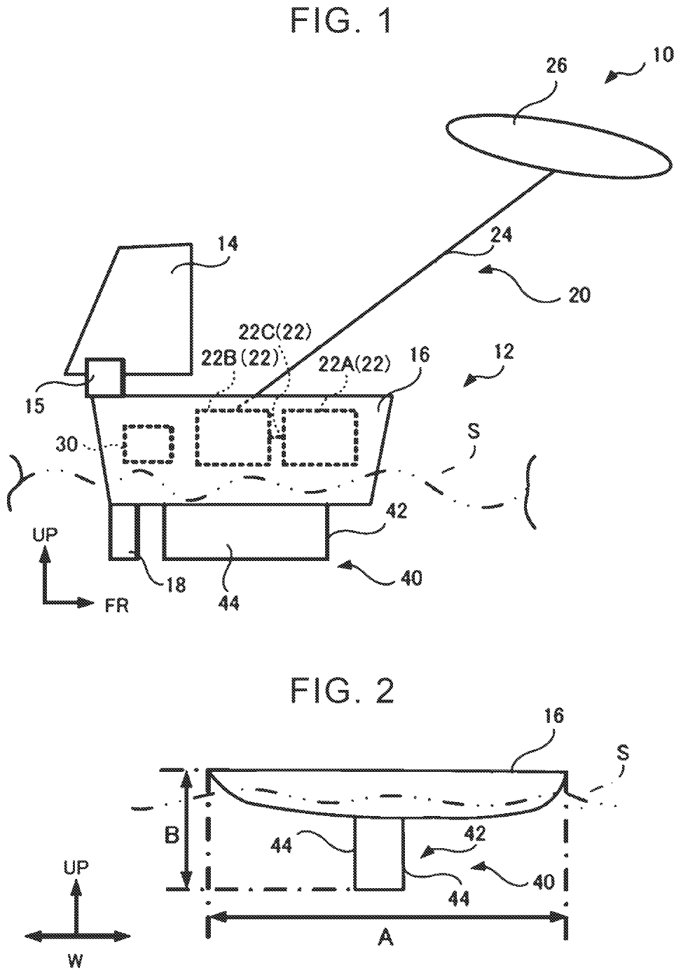

Hereinafter, a floating wind power generation system 10 using a sailing ship 12 according to a first embodiment of the present disclosure will be described using FIGS. 1 to 6. Note that the arrow UP shown as appropriate in each figure indicates the upper side in the vertical direction of the hull, and the arrow FR indicates the front in the longitudinal direction of the hull. Further, arrow W indicates the hull width direction. Furthermore, in each figure, only some of the reference numerals are shown and others are omitted, giving priority to the ease of viewing the drawings.

As shown in FIG. 1, the floating wind power generation system 10 includes a sailing ship 12 operated on the sea, a lake, a river, etc., a power generation system 20 that generates electric power, and steering control of the sailing ship 12, drive control of the power generation system 20, etc. It is equipped with a control device 30 that performs the following. Although not shown in the drawings, the control device 30 as a control unit includes various electrical devices (electrical components), a control unit, and the like. The control unit has a Central Processing Unit (CPU), Read Only Memory (ROM), Random Access Memory (RAM), storage, communication interface (communication I/F), and input/output interface (input/output I/F). It is composed of: A generator 22A, which will be described later, is connected to the input/output I/F.

### Configuration of Power Generation System 20

The power generation system 20 includes, for example, a power generation device 22 disposed on the hull 16 and a kite 26 connected to the hull 16 via a tether 24. The kite 26 is composed of a kite body, and is moored onto the hull 16 by a tether 24.

The power generation device 22 includes a generator 22A and a winch 22B. A rotating shaft 22C is connected to the rotating shaft of the generator 22A, and the generator 22A rotates the rotating shaft 22C based on a command from the control device 30. The winch 22B has a rotating shaft 22C as a rotating shaft, and a tether 24 is wound around the rotating shaft 22C. The power generation device 22 lets out the tether 24 from the winch 22B or winds the tether 24 around the winch 22B by rotating the rotating shaft 22C clockwise or counterclockwise.

In the power generation system 20, when the kite 26 rises, the tether 24 is let out from the winch 22B as the kite 26 rises. This drawing-out operation of the tether 24 rotates the rotating shaft 22C, and the rotating shaft of the generator 22A rotates in conjunction with the rotation of the rotating shaft 22C, thereby generating electricity. The amount of power generation Q due to the rise of the kite 26 is a value obtained by multiplying the tension of the tether 24 by the speed at which the tether 24 is let out.

Then, after the tether 24 is paid out to a predetermined length or after a predetermined time period has elapsed, based on the instruction from the control device 30, the rotating shaft 22C is rotated in the opposite direction, that is, in the direction in which the tether 24 is wound up, by a motor (not shown) via the generator 22A, for example. As a result, the tether 24 is wound up, and the kite 26 descends. Note that the amount of power generation Q due to the ascent of the kite 26 is larger than the power used when winding up the tether 24.

The power generation system 20 generates power by repeatedly performing the unwinding and winding operations of the tether 24.

### Configuration of Sailing Ship 12

As shown in FIG. 1, the sailing ship 12 includes a hull 16 with a sail 14. The hull 16 is a main body of a floating body configured to float on the water surface S in the sea, lake, river, etc., and the bottom of the hull 16 located in the water exerts buoyancy, which is an upward force equivalent to the weight of the water displaced. Further, the hull 16 includes a rudder 18 as a steering device, and a lateral force generating unit 40 that generates a lateral force, which will be described later, on the bottom portion located below the water surface S.

The sail 14 is made of a membrane material and includes a soft sail made of an elastic material that expands with the wind. In the present embodiment, the sail 14 is made of a soft sail as an example, but the present disclosure is not limited to this. For example, the sail 14 may be made of a hard sail made of a hard material having an airfoil shape. It's okay. Further, the number of sails 14 is not limited to one, and a plurality of sails may be provided.

The sail 14 is fixed to the hull 16 via a mast 15, and the base portion of the mast 15 is rotatable with respect to the hull 16. By rotating the base portion of the mast 15 with respect to the hull 16, the sail angle αs, which will be described later, can be set to an arbitrary angle. The mast 15 is driven and controlled by the control device 30 described above. In addition, in the case where the mast 15 is configured to be operated manually, the control device 30 notifies the amount of rotation, etc. for setting the sail angle αs to a desired angle by means of a display, voice, etc. (not shown). In addition, in this embodiment, as an example, the sail angle αs is changed by rotating the base portion of the mast 15 with respect to the hull 16, but the present disclosure is not limited to this, and the method of changing the sail angle αs is can be changed as appropriate.

As shown in FIG. 1, the rudder 18 has a flat surface, is provided on the rear side of the bottom surface of the hull 16, and controls the direction of the bow 16A of the hull 16. Specifically, the rudder 18 is configured to be rotatable, and by rotating it changes the direction of the underwater flow, and by changing the underwater flow, the direction of the bow 16A is changed. The rudder 18 is driven and controlled by the control device 30 described above. In addition, in the case where the rudder 18 is configured to be operated manually, the control device 30 notifies the amount of movement and the like for moving the bow 16A of the hull 16 in a desired direction using the above-mentioned notifying means (not shown).

Note that the method for controlling the direction of the bow 16A of the hull 16 is not limited to the rudder 18, and any known technique such as a thruster (propulsion device) that generates a moment in the direction of the bow 16A may be used.

As shown in FIGS. 1 and 2, the lateral force generating unit 40 is provided on the bottom surface of the hull 16, and in this embodiment, extends in the longitudinal direction at the widthwise center of the hull 16. It has a board 42 as a fixed plate material. As shown in FIG. 2, the board 42 increases the depth dimension B relative to the overall length dimension A in the width direction of the hull 16. The board 42 generates a lateral force Fb, which will be described later, in a direction substantially perpendicular to the direction in which the hull 16 moves.

### Thrust Generation Method Using Sail 14

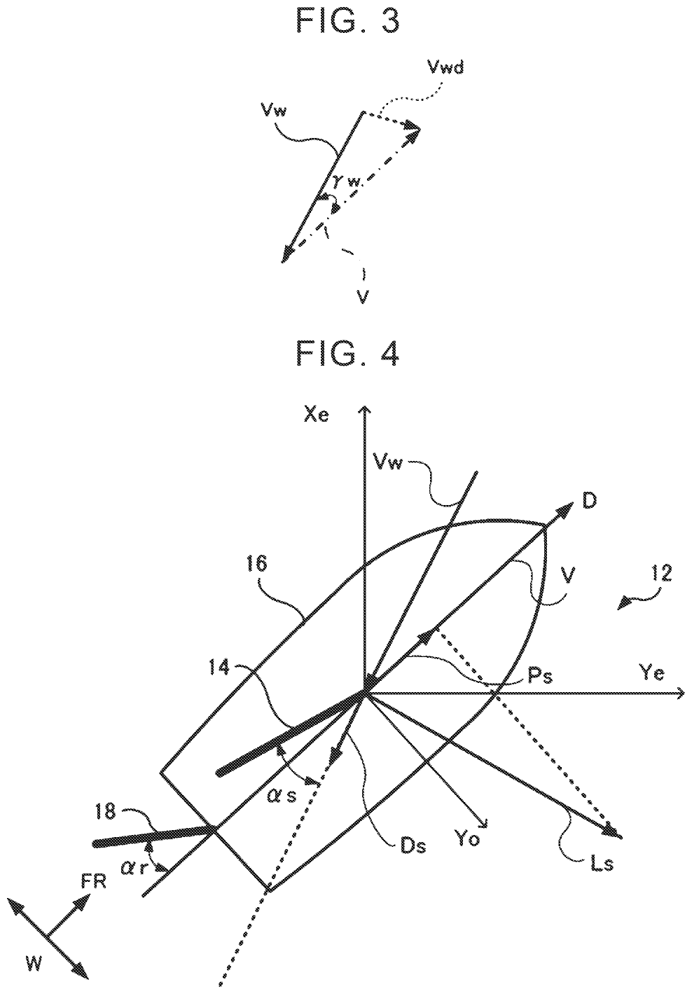

Next, a method of generating thrust by the sail 14 will be explained. In this embodiment, the sail 14 utilizes natural wind power to generate propulsive force. FIG. 3 is a diagram showing the relationship between relative wind speed, traveling speed, and wind speed with respect to the sailing ship 12. In addition, in FIG. 3, the direction of the vector represents the wind direction, and the magnitude of the vector represents the speed. As shown in FIG. 2, the relative wind speed Vw with respect to the sailing ship 12 shown by the solid line is expressed as a composite speed of the wind speed Vwd of the natural wind shown by the dotted line and the traveling speed V of the sailing ship 12 shown by the dashed-dotted line. This relative speed Vw is detected by a wind direction and wind speed sensor (not shown) mounted on the hull 16. Specifically, the wind direction and speed sensor detects a relative wind direction γw and a relative wind speed Vw, which are wind directions relative to the sailing ship 12.

As shown in FIG. 3, the lift force Ls and the drag force Ds change as the sail angle αs, which is the angle of attack between the sail 14 and the relative wind speed Vw, changes. Lift force Ls is generated in a direction perpendicular to relative wind speed Vw, and drag force Ds is generated in the same direction as relative wind speed Vw. Then, the component in the traveling direction D of the sailing ship 12 in the combined force of both the lift force Ls and the drag force Ds becomes the propulsive force Ps by the sail 14. The larger the sail angle αs, the greater the propulsive force Ps, and the greater the propulsive force Ps, the faster the moving speed of the sailing ship 12 becomes.

Note that the values of the lift force Ls and the drag force Ds with respect to the sail angle αs are characteristics unique to each sailing ship 12. Therefore, the values of the lift force Ls and the drag force Ds with respect to the sail angle αs are obtained in advance through a wind tunnel test and Computational Fluid Dynamic (CFD).

### Lateral Force Generation Method

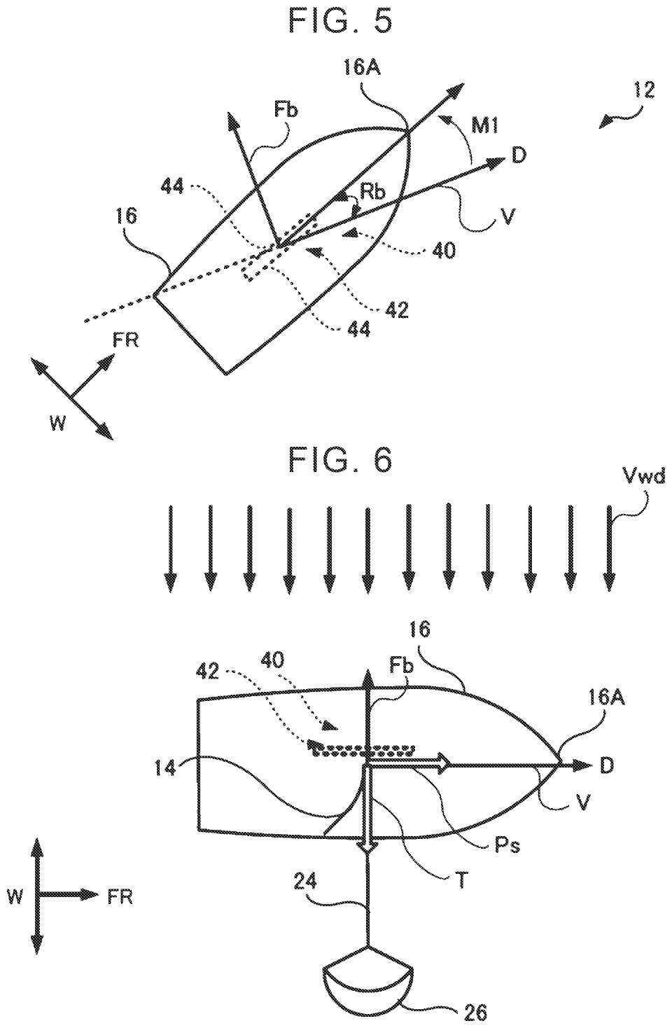

Next, a method of generating lateral force in the sailing ship 12 will be explained. If the side surfaces 44 on both sides of the board 42 in the width direction of the hull 16 have an angle with respect to the water flow, the water flow will hit either of the side surfaces 44 on both sides, and the board 42 will move in the direction of travel of the hull 16. A lateral force Fb is generated in a direction substantially perpendicular to the direction. Specifically, as shown in FIG. 5, by tilting the bow 16A of the hull 16 in the direction of arrow M1, for example, with respect to the traveling direction D of the hull 16, the traveling direction D of the hull 16 and the side surface of the board 42 are adjusted. 44 is the board angle Rb. This allows the side surface 44 of the board 42 to form an angle with respect to the flow of water, allowing the board 42 to generate a lateral force Fb. Note that the direction of the bow 16A of the hull 16 is controlled by the rudder 18 described above.

Further, the lateral force Fb generated by the board 42 increases as the speed of the water flow hitting the side surface 44 increases. That is, the faster the moving speed of the hull 16 is, the faster the relative speed of the water flow hitting the side surface 44 becomes. Therefore, in order to generate a larger lateral force Fb by the board 42, the propulsive force Ps by the sail 14 is increased. The control device 30 generates the propulsive force Ps such that the lateral force Fb generated by the board 42 is increased as compared with a component of a direction orthogonal to the traveling direction D of the sailing ship 12 among a component of the force that is a combination of both the lift force Ls and the drag force Ds and the tension T of the tether 24.

### How to Cancel Kite Tension Due to Lateral Force

As described above, the sailing ship 12 of this embodiment is equipped with the power generation system 20 using the kite 26. As shown in equation (1) below, the amount of power generation Q due to the upward movement of the kite 26 is a value obtained by multiplying the tension T of the tether 24 by the payout speed Vt of the tether 24.

$$Q = T \times Vt \qquad ( 1 )$$

The tension T of the tether 24 is the tension generated by the kite 26 (see FIG. 6), and substantially matches the aerodynamic force Pk of the kite 26, as shown in equation (2) below. Further, as shown in equation (3) below, the aerodynamic force Pk of the kite 26 is proportional to the square of the relative wind speed Vwk, which is the composite wind speed of the wind speed Vwd of the natural wind and the flight speed of the kite 26.

$$T \approx Pk \qquad ( 2 )$$

$$Pk ∝ {Vwk}^{2} \qquad ( 3 )$$

Therefore, when the power generation system 20 is mounted on an unmoored sailing ship 12, if the sailing ship 12 is pulled by the tension T of the kite 26, the relative wind speed Vwk will decrease. When the relative wind speed Vwk decreases, the aerodynamic force Pk of the kite 26 also decreases, so the tension T also decreases. When the tension T decreases, the amount of power generation Q decreases.

As shown in FIG. 6, when the wind direction is downward in FIG. 6, the kite 26 that is generating power is often located on the leeward side. Therefore, when the sailing ship 12 is not moored, the tension T by the kite 26 causes the sailing ship 12 to be pulled in the leeward direction. Therefore, in this embodiment, the tension T caused by the kite 26 is reduced by the lateral force Fb generated by the board 42. Specifically, the control device 30 controls the sail angle αs so that the lateral force Fb generated by the board 42 becomes larger. That is, the control device 30 increases the sail angle αs so that the propulsive force Ps becomes larger. Further, the control device 30 controls the traveling direction of the hull 16 so that the lateral force Fb generated by the board 42 acts in the opposite direction to the tension T caused by the kite 26. That is, the control device 30 changes the rudder angle αr so that the lateral force Fb acts in the opposite direction to the tension T by the kite 26.

Normally, the lateral force Fb generated by the board 42 acts in a direction substantially perpendicular to the direction of movement of the hull 16. Therefore, when the kite 26 is located on the leeward side, the control device 30 performs control so that the traveling direction of the hull 16 is in the windward direction. Here, the windward direction includes the direction of the window beam that is substantially orthogonal to the wind direction. Specifically, the direction of movement of the hull 16 is controlled by controlling the rudder angle αr (see FIG. 4) based on a command from the control device 30. In this embodiment, the control device 30 controls the rudder angle αr so that the vector direction of the tension T of the kite 26 and the traveling direction D of the hull 16 are substantially orthogonal.

### Effects of the First Embodiment

Next, the effects of the first embodiment will be explained.

In the floating wind power generation system 10 according to the first embodiment, the control device 30 determines that the tension T of the kite 26 connected to the hull 16 including the sail 14 via the tether 24 is the lateral force Fb generated by the board 42. The sail angle αs and the rudder angle αr are controlled so that the sail angle αs and the rudder angle αr are reduced.

That is, as the sail angle αs becomes larger, the propulsive force Ps becomes larger, so that the moving speed of the sailing ship 12 can be increased. As the moving speed of the sailing ship 12 becomes faster, the lateral force Fb generated by the board 42 can be increased, so the tension T of the kite 26 can be reduced. Further, by changing the rudder angle αr, the direction of the bow 16A of the hull 16 can be changed. The closer the traveling direction D of the hull 16 is to the direction substantially orthogonal to the vector direction of the tension T of the kite 26, the more the lateral force Fb in the opposite direction to the tension T of the kite 26 can be generated, so that the tension T of the kite 26 can be efficiently reduced.

In this way, by simply controlling the sail angle αs and the rudder angle αr, the tension T of the kite 26 can be reduced by the lateral force Fb. It is possible to reduce the pulling of the hull 16 by the kite 26 with less energy than when using a propulsion device such as the above. Thereby, it is possible to suppress a decrease in the relative wind speed Vwk to the kite 26, so it is possible to suppress a decrease in power generation efficiency with less energy.

Further, in the floating wind power generation system 10 according to the first embodiment, the control device 30 controls the rudder angle αr so that the vector direction of the tension T of the kite 26 and the traveling direction D of the hull 16 are substantially perpendicular to each other when viewed from above the hull 16. In this way, by making the traveling direction D of the hull 16 substantially orthogonal to the vector direction of the tension T of the kite 26, the lateral force Fb, which is approximately orthogonal to the traveling direction D of the hull 16, is made to be opposite to the vector direction of the tension T of the kite 26. It can be applied in the direction. Thereby, the tension T of the kite 26 can be reduced more effectively.

Further, in the floating wind power generation system 10 according to the first embodiment, the lateral force generating unit 40 is provided on the bottom surface of the hull 16, and is fixed so as to extend in the longitudinal direction at the widthwise center of the hull 16. It has a board 42 as a plate material. By providing the board 42 on the bottom surface of the hull 16 in this manner, the depth dimension B of the hull 16 relative to the overall length dimension A in the width direction can be increased by the board 42. Therefore, the lateral force Fb can be increased by the depth dimension B of the board 42.

In the first embodiment, the board 42 is made of a substantially rectangular plate material as shown in FIGS. 1 and 2, but the present disclosure is not limited to this. For example, the board 42 may be configured to have an airfoil cross-sectional shape.

### First Modification

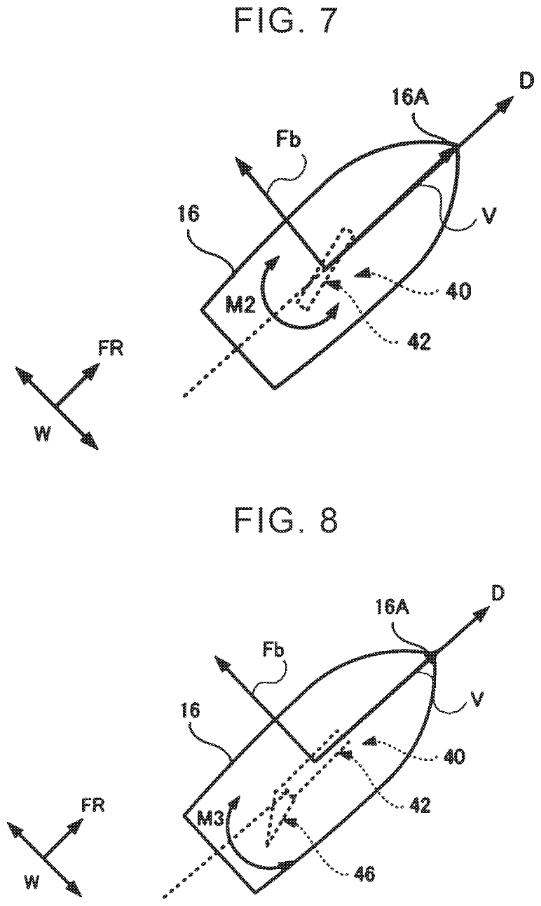

Further, in the first embodiment, the board 42 is fixed to the bottom surface of the hull 16, but the present disclosure is not limited to this. As shown in FIG. 7, the board 42 may be rotatably fixed to the hull 16. In this case, the necessary lateral force Fb is generated by rotating the entire board 42 in the direction of arrow M2 according to a command from the control device 30.

### Second Modification

Further, as shown in FIG. 8, the lateral force generating unit 40 may include a movable unit 46 connected to the end of the board 42 on the rear side of the hull 16 so as to be rotatable in the direction of arrow M3 with respect to the board 42. As an example, the movable unit 46 is formed to have substantially the same width as the board 42 on the board 42 side, and is formed to become tapered toward the opposite side from the board 42. In such a configuration, the necessary lateral force Fb is generated by rotating the movable unit 46 in the M3 direction according to a command from the control device 30.

### Modification Example 3

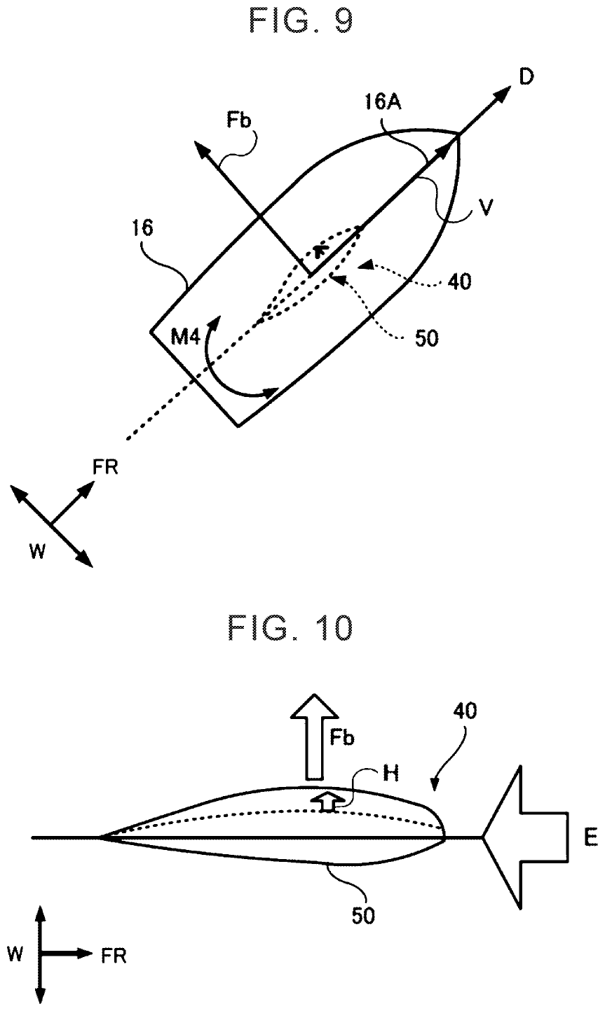

Further, as shown in FIG. 9, the lateral force generating unit 40 may not include the board 42 described above, but may include a board 50 whose cross-sectional shape in the horizontal direction is variable. As shown in FIG. 10, the board 50 is configured so that its dimension in the hull width direction can be changed. That is, the board 50 changes the shape shown by the dotted line on at least one side in the hull width direction to the shape shown by the solid line expanding outward (in the direction of arrow H in the figure) in response to a command from the control device 30. In the case of such a configuration, by inflating the side on which the lateral force Fb is desired to be generated by a command from the control device 30, the flow velocity E is biased and the lateral force Fb is generated.

Specifically, the board 50 is configured with a balloon-shaped membrane surface, for example, and an inflatable mechanism that changes the shape by applying internal pressure with gas or the like to inflate the inside can be used. Further, the board 50 may be configured with variable parts, for example, and may use a morphing mechanism that changes the shape by deforming the variable parts. The board 50 can be modified using known techniques.

Further, in the first embodiment and modifications 1 to 3, the lateral force generating unit 40 has the board 42, but the present disclosure is not limited to this, and the present disclosure may not include the boards 42, 50.

### Second Embodiment

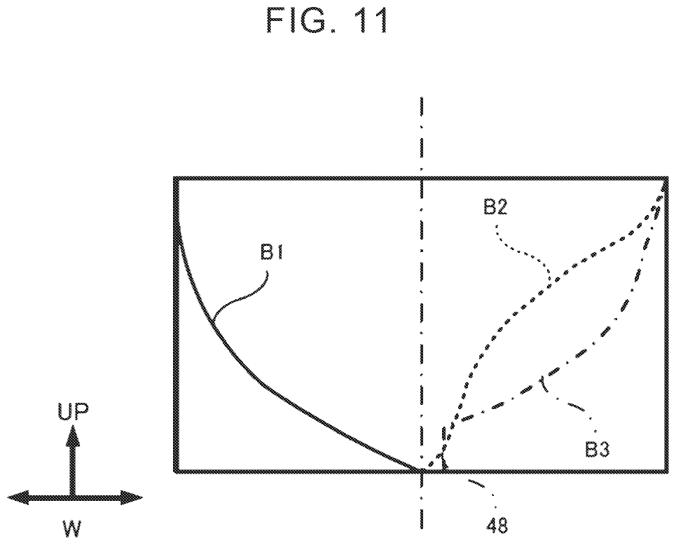

Hereinafter, a floating wind power generation system according to a second embodiment of the present disclosure will be described using FIG. 11. In the floating wind power generation system of the second embodiment shown in FIG. 11, the same parts as in the first embodiment are indicated by the same reference numerals, and the explanation thereof will be omitted, and only the different parts will be explained.

FIG. 11 is a front view showing the lower structure of the sailing ship 12 according to the second embodiment. The shape indicated by the solid line B1 on the left side of FIG. 11 is the shape of a conventional sailing ship, and the shape indicated by the dotted line B2 on the right side of FIG. 11 is a shape with a larger ratio of depth to width than the conventional sailing boat. That is, compared to conventional sailing ships, the width dimension near the vertical center of the hull is particularly reduced without changing the depth dimension. This makes it possible to increase the flow velocity around the hull, making it easier for lateral force Fb to occur.

Further, the shape shown by the dashed line B3 on the right side of FIG. 11 forms a keel 48 extending in the longitudinal direction of the hull at the center in the widthwise direction of the hull, without changing the depth dimension compared to conventional sailing ships. By forming the keel 48 in this manner, the magnitude of the lateral force Fb can be changed by changing the depth dimension of the keel 48.

In addition, in the embodiment mentioned above, the sailing ship 12 has one hull 16, but the present disclosure is not limited to this. For example, the sailing ship 12 may include a bihull, such as a catamaran and a trimaran, in which two or more hulls are connected in parallel on the deck. The lateral force generating unit 40 of the embodiment described above can also be applied to this multihull shape.

Further, in the floating wind power generation system 10 according to the embodiment described above, the control device 30 controls the rudder angle αr so that the vector direction of the tension T of the kite 26 and the traveling direction D of the hull 16 are substantially perpendicular to each other when viewed from above the hull 16, but the present disclosure is not limited to this. For example, the rudder angle αr may be controlled so that the vector direction of the tension T of the kite 26 and the traveling direction D of the hull 16 are within a range of approximately ±10° from a direction that is substantially orthogonal to each other when viewed from above the hull 16. However, this range changes depending on the area of the kite 26 and the wind speed Vwd, and the range becomes narrower as the area of the kite 26 and the wind speed Vwd become larger. In the present disclosure, the control device 30 only needs to be able to control the rudder angle αr so as to generate the lateral force Fb in a direction that cancels out the tension T of the kite 26.

Further, in the embodiment described above, the rudder angle αr is controlled in order to change the traveling direction D of the hull 16, but the present disclosure is not limited to this. For example, the traveling direction D of the hull 16 may be changed by increasing the propulsive force Ps to generate a larger lateral force Fb by controlling the sail angle αs. Further, the traveling direction D of the hull 16 may be changed by controlling both the rudder angle αr and the sail angle αs.

Although one embodiment of the present disclosure has been described above, the present disclosure is not limited to such an embodiment, and one embodiment and various modifications may be used in combination as appropriate, and the gist of the present disclosure may be It goes without saying that the disclosure can be implemented in various ways without departing from the scope.

What is claimed is:

1. A floating wind power generation system using a sailing ship, comprising:
a hull including a sail;
a kite connected to the hull via a tether;
a lateral force generating unit that generates a lateral force in a direction substantially orthogonal to a front-rear direction of the hull;
a steering device that controls a direction of a bow of the hull; and
a control unit that controls at least one of an angle of the sail and the steering device such that tension of the kite is reduced by the lateral force.

2. The floating wind power generation system using the sailing ship according to claim 1, wherein the control unit controls at least one of the angle of the sail and the steering device such that a vector direction of the tension of the kite and a traveling direction of the hull are substantially orthogonal to each other when viewed from above the hull.

3. The floating wind power generation system using the sailing ship according to claim 2, wherein the lateral force generating unit includes a plate member on a bottom surface of the hull, the plate member being provided to extend in the front-rear direction of the hull.

4. The floating wind power generation system using the sailing ship according to claim 2, wherein in the lateral force generating unit, a ratio between a depth dimension and a width dimension is increased by reducing the width dimension as the depth dimension increases at a bottom portion of the hull located below a water surface.

5. The floating wind power generation system using the sailing ship according to claim 2, wherein the lateral force generating unit is provided with a keel extending in the front-rear direction of the hull at a bottom portion of the hull located below a water surface.
